(19) United States
(12) Patent Application Publication
(10) Pub. No.: US 2018/0204697 A1
(43) Pub. Date: Jul. 19, 2018

(54) MAGNETIC POWER SUPPLY COUPLING SYSTEMS AND METHODS

(71) Applicant: OpenTV, Inc., San Francisco, CA (US)

(72) Inventors: Scott JANTZ, Gainesville, FL (US); Nir LIVAY, Gainesville, FL (US)

(73) Assignee: OpenTV, Inc., San Francisco, CA (US)

(21) Appl. No.: 15/408,161

(22) Filed: Jan. 17, 2017

(51) Int. Cl. H01H 50/16; B65D 85/38; B65D 25/20

(52) U.S. Cl. CPC H01H 50/16; B65D 25/20; B65D 85/38

(57) ABSTRACT

A power supply coupling circuit may include at least one reed switch connecting a power supply with a load and disposed within an electronic device. A predetermined arrangement of one or more external magnets may be required to open the at least one reed switch to disconnect the power supply from the load.

### BACKGROUND

Battery-powered electronic devices such as smartphones or other consumer electronics may be configured with internal batteries that may be difficult to remove or disable from the outside. For example, many devices may be assembled in such a way that a user cannot access the battery without tools. Some devices may have no mechanical buttons controlling power or other functions. Accordingly, it may be difficult to disconnect device circuitry from an internal power source during shipping, hard reset, or other situations where such disconnection may be desired.

### BRIEF DESCRIPTION OF THE DRAWINGS

FIG. 1A is a circuit including a normally closed reed switch according to an embodiment of the invention.

FIG. 1B is a circuit including an open reed switch according to an embodiment of the invention.

FIG. 2 is a circuit including a plurality of reed switches according to an embodiment of the invention.

FIG. 3 is a mobile device according to an embodiment of the invention.

FIG. 4 is a shipping device according to an embodiment of the invention.

FIG. 5 is a reed switch and a magnet assembly according to an embodiment of the invention.

FIG. 6 is a reed switch and magnetic field according to an embodiment of the invention.

FIG. 7 is a reed switch and magnetic field according to an embodiment of the invention.

FIG. 8A is a mobile device according to an embodiment of the invention.

FIG. 8B is a mobile device according to an embodiment of the invention.

### DETAILED DESCRIPTION OF SEVERAL EMBODIMENTS

Systems and methods described herein may integrate at least one magnetic switch, such as a reed switch, into an electronic device. A magnetic switch may open and close under the influence of magnetic fields. The magnetic switch may be disposed between the device power supply and other circuit elements. The switch may be normally closed and may be configured to open in the presence of a specific magnetic field. The switch may be configured so that it does not open in the presence of magnetic fields other than the specific magnetic field. For example, to guard against accidental battery disconnect from exposure to a magnetic field, only a specific arrangement of magnets in one or more specific locations may be able to disengage the battery.

For example, during a shipping operation, an electronic device may be stored on a shipping case in a shipping tray. The magnetic switch(es) may be opened with a magnet or group of magnets located at a specific location(s) on the shipping tray. When exposed to the shipping tray magnets, the switch(es) may disconnect the battery, allowing for safe shipping with a physically disconnected battery.

In another example, a user may retain the shipping case and place the electronic device in the case to disconnect the battery to perform a hard reboot of the device.

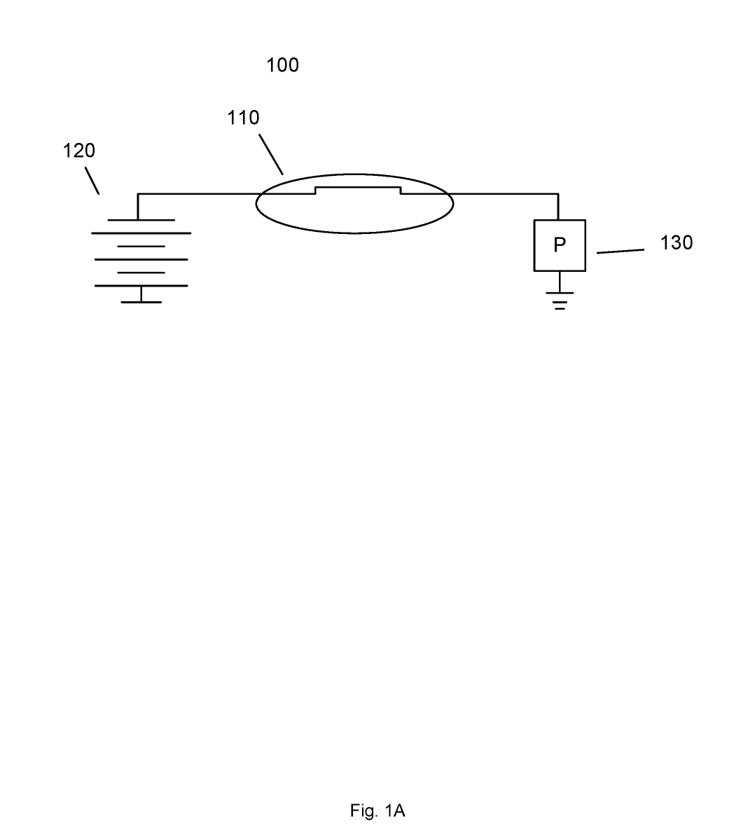

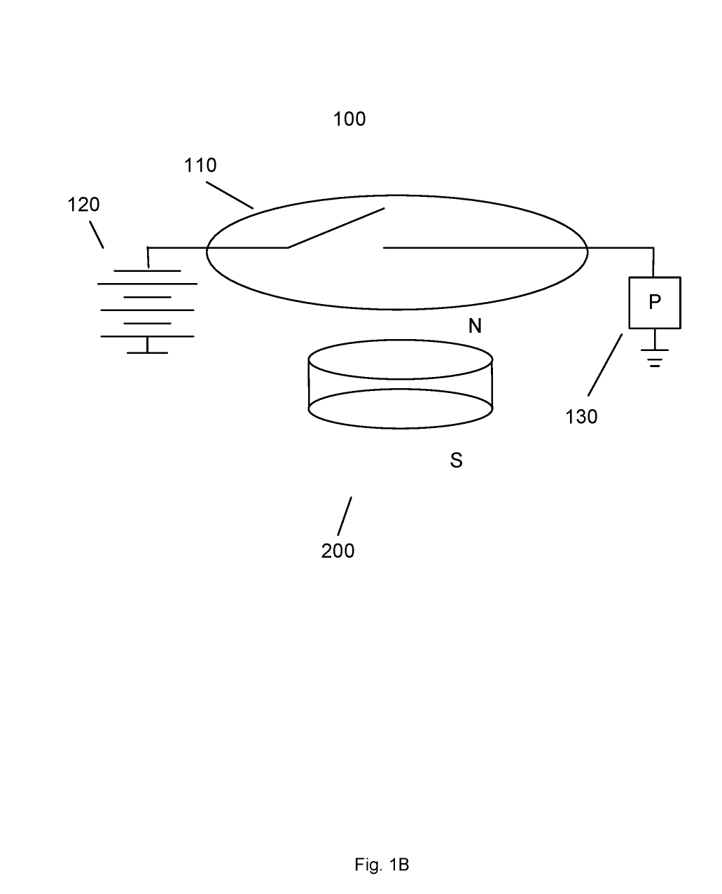

An electronic device may include a circuit that can couple and decouple a power supply from a load. FIG. 1A is a circuit 100 including a normally closed reed switch 110 according to an embodiment of the invention. Circuit 100 may include power supply 120 (e.g., a battery) and load 130 (e.g., device electronics such as a processor, transceivers, display element, etc.). Normally closed reed switch 110 may connect power supply 120 and load 130, allowing power supply 120 to power load 130. In some example embodiments, reed switch 110 may be a single pole single throw glass body reed switch rated to operate within voltage, current, power, and temperature ranges that are compatible with those of power supply 120. In some embodiments, such as the “magnetic lock” embodiments described below, reed switch 110 may be a normally open switch.

Opening reed switch 110 may disconnect power supply 120 from load 130. FIG. 1B shows the circuit 100 wherein reed switch 110 is open. Normally closed reed switch 110 may open when exposed to a magnetic field from magnet 200. A single magnet 200 is shown in FIG. 1B to illustrate the basic operation of reed switch 110. However, in some embodiments, reed switch 110 may be configured to open only when exposed to a specific arrangement of magnets 200 producing a specific magnetic field. In some example embodiments, magnets 200 may be neodymium magnets or other magnets configured to generate powerful localized magnetic fields (e.g., 1/16″ diameter× 1/32″ thick flat magnets with poles on flat ends).

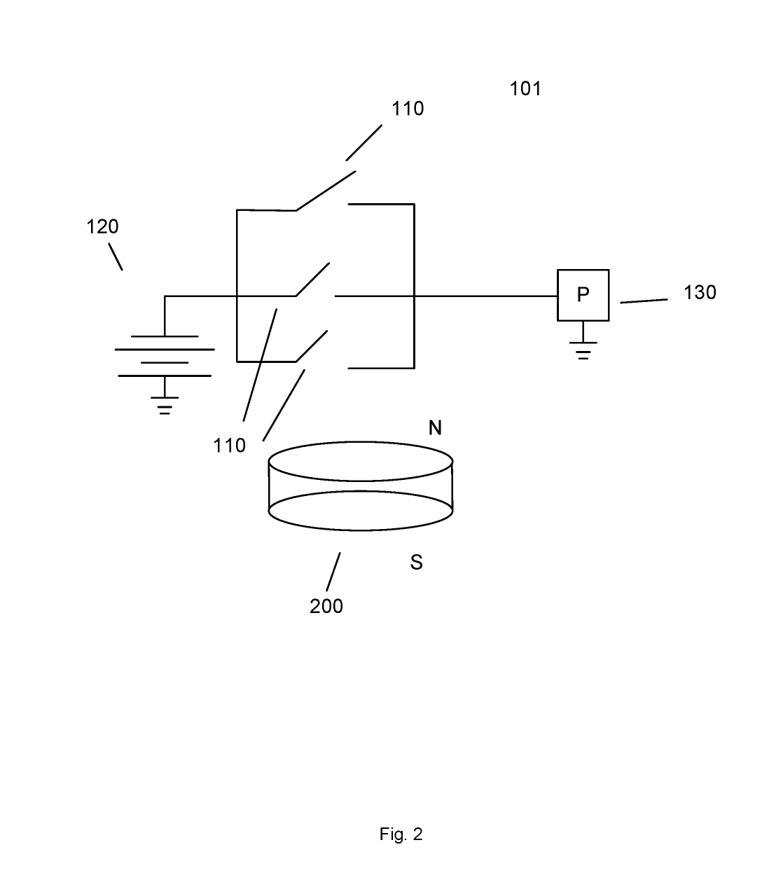

FIG. 2 is a circuit 101 including a plurality of reed switches 110 according to an embodiment of the invention. In some embodiments, several switches 110 may be operated in parallel (wired OR mode) to prevent accidental switching. For example, in circuit 101, three reed switches 110 are placed between power supply 120 and load 130 in parallel. In order to disconnect power supply 120 from load 130, each switch 110 must open. If any single switch 110 or subset of switches 110 remains open, power supply 120 may still be able to supply power to load 130. This arrangement may ensure that only a specific external arrangement of magnets 200 and resulting specific magnetic field can disconnect power supply 120 from load 130. For example, reed switches 110 may be spaced apart from one another so that a magnet 200 close enough to one of the switches 110 to close that switch 110 may be too far from the other switches 110 to close them.

Switches 110 may be positioned in device 10 so that the same magnetic field, if strong enough to operate at least one of switches 110, may cause at least one other switch 110 to be in a state (open or closed) opposite the state of another of switches 110. In this embodiment, at least two different magnetic fields with different orientations may be required to disconnect power supply 120 from load 130.

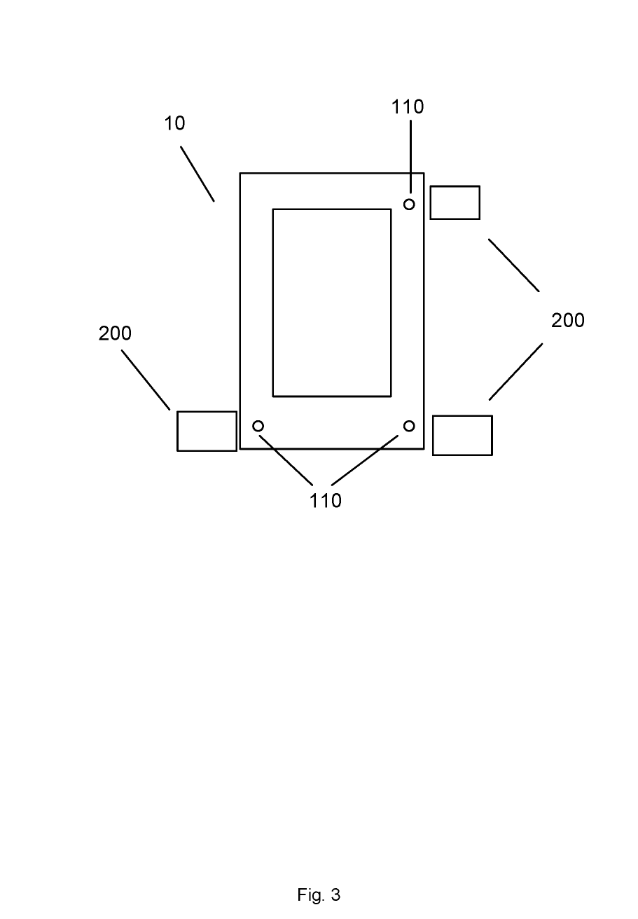

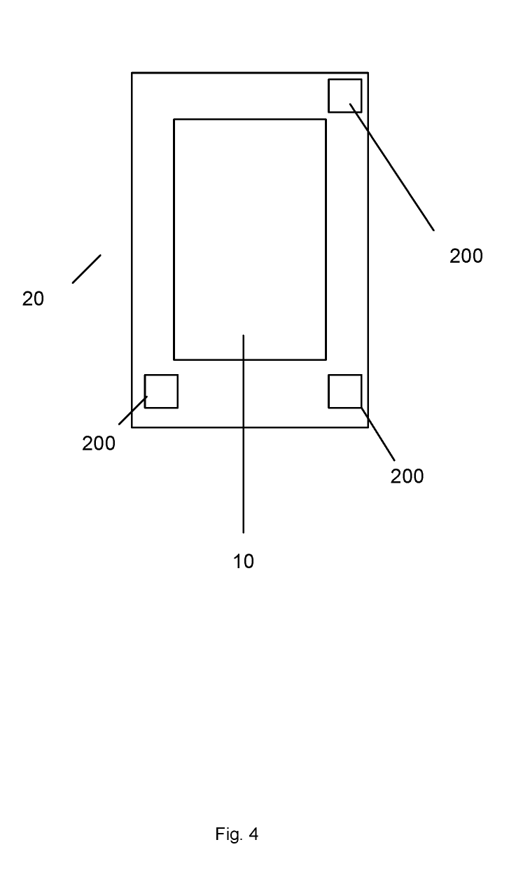

Circuit 100 may be disposed in a mobile electronic device such as a smartphone. FIG. 3 is a mobile device 10 according to an embodiment of the invention. In this embodiment, multiple reed switches 110 (e.g., as in circuit 101) may be disposed at various points within device 10. Accordingly, power supply 120 may be disconnected from load 130 only when magnets 200 are near each reed switch 110. For example, switches 110 may be arranged at several locations along a periphery of device 10. Switches 110 may be positioned inside device 10 and close to a case of device 10 so that they can be opened by local magnetic fields provided by magnets 200 positioned near the outside of the case and near the locations where switches 110 are positioned. In some embodiments, it may be desirable to predictably provide the correct arrangement of magnets 200 to open all switches 110 in circuit 101. FIG. 4 is a shipping device 20 including a plurality of magnets 200 according to an embodiment of the invention. Shipping device 20 may include a box or other packaging for device 10. Magnets 200 may be attached to or embedded in shipping device 20 at specific points. For example, if shipping device 20 is made of cardboard or a similar material, magnets 200 may be glued to the cardboard. If shipping device 20 is made of Styrofoam or a similar material, magnets 200 may be embedded within the Styrofoam. Device 10 may be placed inside or on shipping device 20. Magnets 200 may be arranged in shipping device 20 so that when device 10 is placed in or on shipping device 20 in a predetermined orientation, magnets 200 open each switch 110 in device 10. Accordingly, when device 10 is packaged for shipping, switches 110 may disconnect power supply 120 from load 130. This may allow device 10 to be shipped safely with its power supply 120 installed but disconnected when device 10. When device 10 is removed from shipping device 20, one or more switches 110 may close. Closed switches 110 may connect power supply 120 and load 130, and device 10 may be started. Switches 110 may be arranged in a specific pattern in device 10 so that magnets 200 in shipping device 20 only disconnect power supply 120 from load 130 when device 10 is placed in shipping device 20 in a specific orientation.

Shipping device 20 may be used to perform hard resets of device 10. For example, a user may place device 10 in or on shipping device 20 in the predetermined orientation, which may be the same orientation used when packing device 10 for shipping in some embodiments. When device 10 is placed in the predetermined orientation, magnets 200 in shipping device 20 may open each switch 110 in device 10. Accordingly, switches 110 may disconnect power supply 120 from load 130, effecting a hard reset of device 10 (e.g., powering down load 130 elements to allow them to reset). When device 10 is removed from shipping device 20, one or more switches 110 may close. Closed switches 110 may reconnect power supply 120 and load 130, and device 10 may be restarted. In some embodiments, instructions and/or alignment markings may be printed on shipping device 20 or otherwise included with shipping device 20 to instruct a user on the proper orientation for device 10 within shipping device 20 to perform a hard reset.

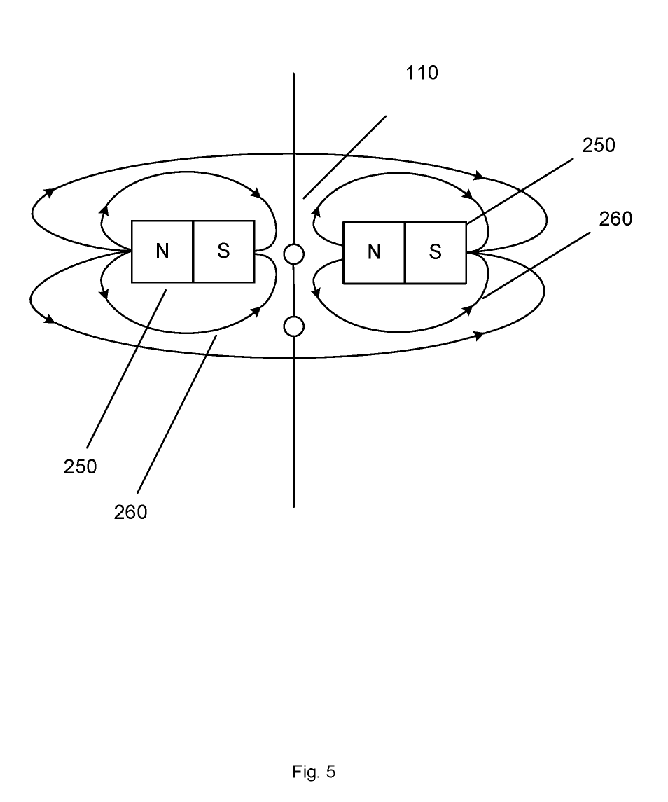

In some embodiments, device 10 may include one or more reed switches 110 and one or more internal magnets 250 that may be configured so that only a precise external magnetic field causes reed switches 110 to close. For example, reed switches 110 may be normally open switches in these embodiments. Internal magnets 250 may form “magnetic locks” holding the normally open reed switches 110 closed. External magnetic fields may interfere with the magnetic fields produced by internal magnets 250 to cancel each other out, removing or reducing the magnetic fields from reed switches 110 and causing them to open. Such switches 110 and internal magnets 250 may be used in either circuit 100 including a single switch 110 or circuit 101 including multiple switches 110. FIG. 5 is a reed switch 110 and an assembly of magnets 250 according to an embodiment of the invention. Magnets 250 may be disposed in device 10 in the vicinity of switch 110. Magnets 250 may form a combined magnetic field in the vicinity of switch 110 from their individual magnetic fields 260. Magnets 250 may be oriented to produce a combined magnetic field that closes switch 110.

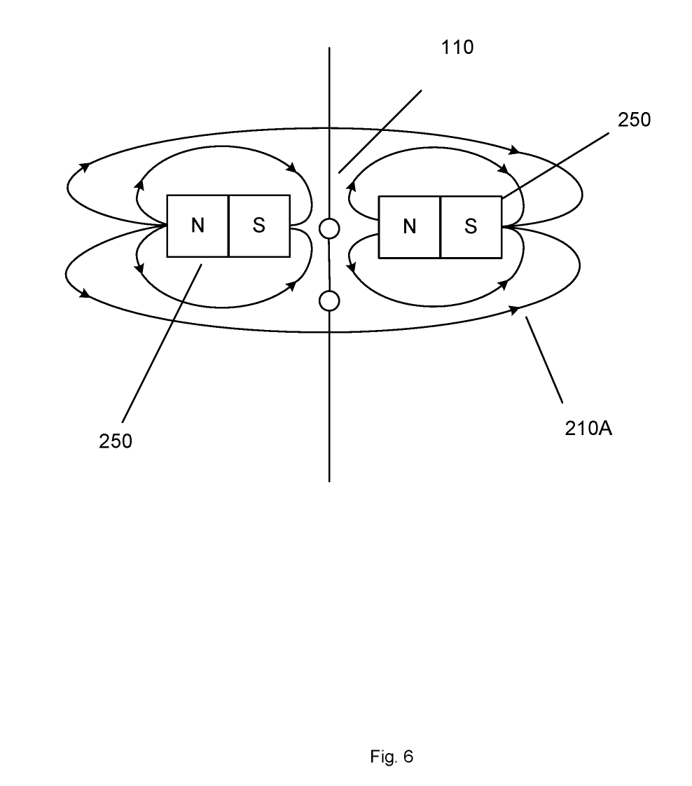

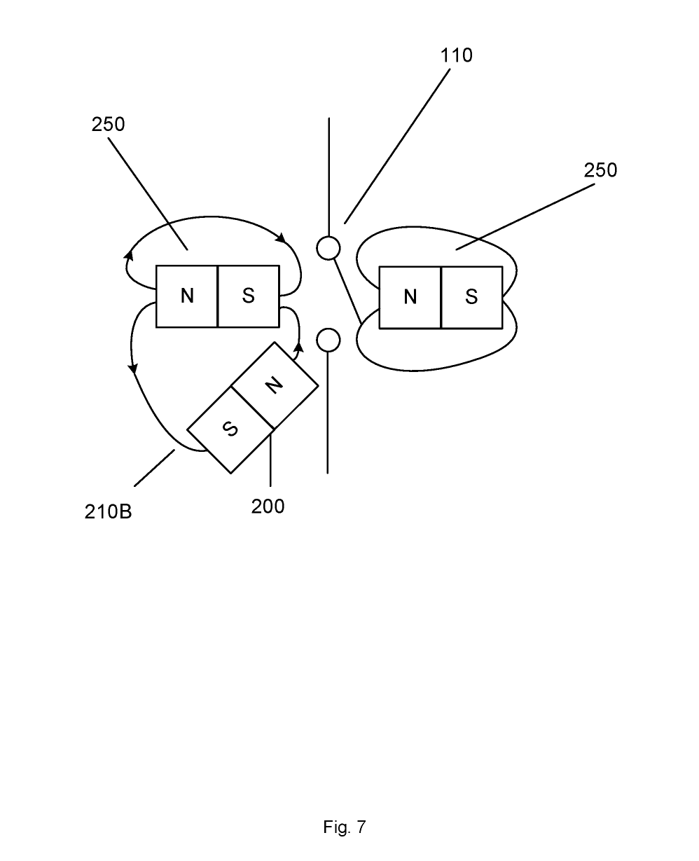

FIGS. 6 and 7 are reed switches 110 and magnetic fields 210 according to an embodiment of the invention. As shown in FIG. 6, internal magnets 250 may be aligned with one another near switch 110 to produce total magnetic field 210A that surrounds switch 110. Because normally open switch 110 is within total magnetic field 210A, total magnetic field 210A may cause switch 110 to close. FIG. 7 illustrates the effect of placing external magnet 200 in a specific location relative to switch 110 (e.g., by correctly placing device 10 in shipping device 20). External magnet 200 may be arranged with poles opposite the poles of a nearby internal magnet 250 within magnetic field 210B. Accordingly, magnetic field 210B may be weakened and no longer present in the vicinity of switch 110. Demagnetized switch 110 may return to its normally open position until magnet 200 is removed. Because of the effect of internal magnets 250, external magnet 200 may have to be very precisely placed relative to switch 110 in order to open switch 110. In some embodiments, multiple external magnets 200 in a specific arrangement may be required to open switch 110.

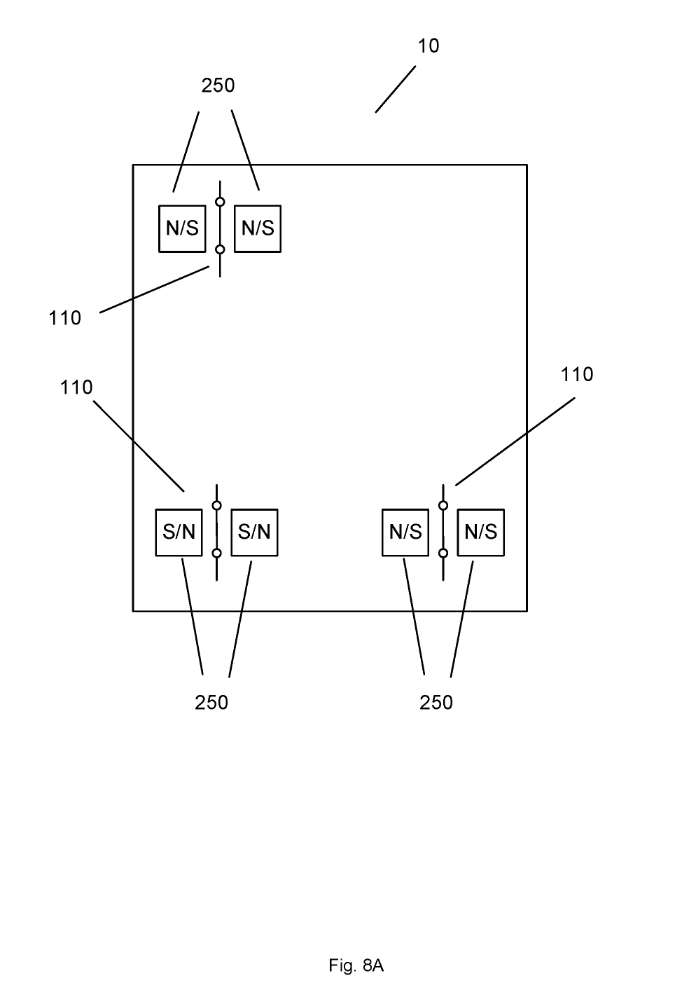

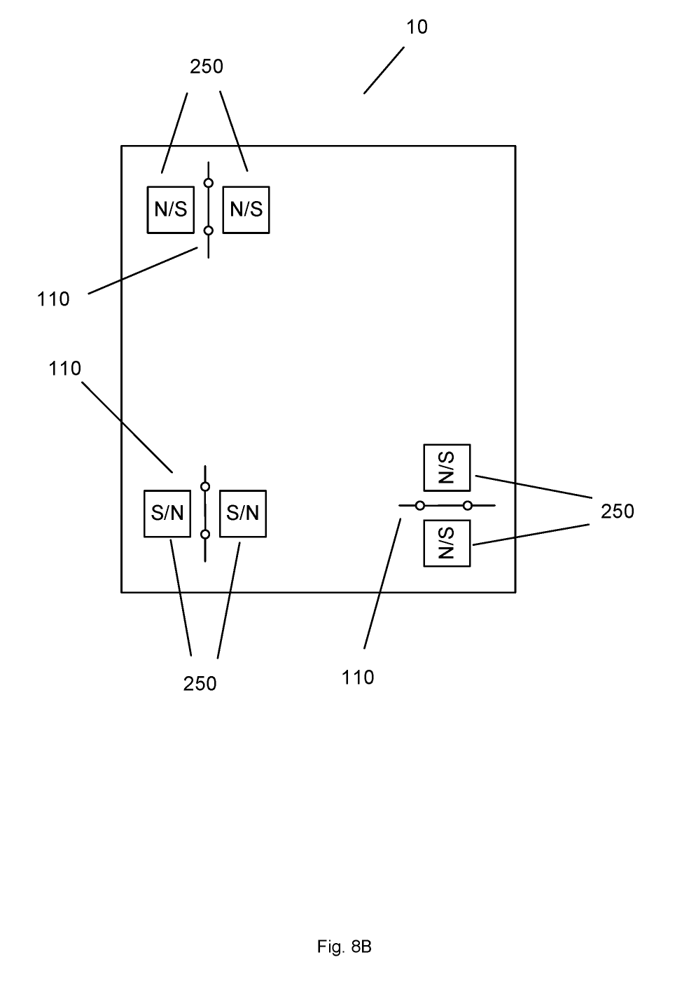

Internal magnets 250 may be arranged in device 10 in such a way to prevent opening of all switches 110 at the same time without placing device 10 in shipping device 20, for example through exposure of device 10 to a strong magnetic field. FIGS. 8A and 8B show a device 10 according to embodiments of the invention. Internal magnets 250 may surround normally-open switches 110 to keep switches 110 closed when device 10 is not installed in shipping device 20. As in FIG. 7, external magnets 200 may be arranged facing an opposite direction from the poles of nearby internal magnets 250 to weaken a magnetic field produced by internal magnets 250. To avoid accidental opening of all switches 110 in the presence of a strong magnetic field, internal magnets 250 may be arranged in different orientations for different switches 110. For example, in device 10 of FIG. 8A with three switches 110, internal magnets 250 around two of the switches 110 are arranged in a north-to-south configuration from the illustrated viewpoint (e.g., a view of the front of device 10). Internal magnets 250 around the third switch 110 (the lower-left switch 110 in the illustrated viewpoint) are arranged in a south-to-north configuration from the illustrated viewpoint. Accordingly, the external magnetic field needed to open the lower-left switch 110 may be directionally opposite the external magnetic field or fields needed to open the other switches 110. This may enhance protection against a single, powerful external magnetic field opening all switches 110, because at least one internal magnet 250 should be directionally aligned with the external magnetic field in any given orientation of device 10 relative to the external magnetic field source.

In device 10 of FIG. 8B with three switches 110, internal magnets 250 around one of the switches 110 are arranged in a north-to-south configuration from the illustrated viewpoint (e.g., a view of the front of device 10). Internal magnets 250 around the second switch 110 (the lower-left switch 110 in the illustrated viewpoint) are arranged in a south-to-north configuration from the illustrated viewpoint. Internal magnets 250 around the third switch 110 (the lower-right switch 110 in the illustrated viewpoint) are arranged in a north-to-south configuration that is rotated ninety degrees from the illustrated viewpoint. Accordingly, the external magnetic field needed to open each switch 110 may be directionally different from the external magnetic field or fields needed to open the other switches 110. This may enhance protection against a single, powerful external magnetic field opening all switches 110, because at least one internal magnet 250 should be directionally aligned with the external magnetic field in any given orientation of device 10 relative to the external magnetic field source.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A power supply coupling circuit comprising:
a power supply;
a load; and
a plurality of reed switches connecting the power supply with the load in parallel with one another;
wherein the plurality of reed switches are disposed in a predetermined arrangement within an electronic device such that a predetermined arrangement of external magnets is required to open each of the plurality of reed switches to disconnect the power supply from the load.

2. The power supply coupling circuit of claim 1, wherein:
at least one of the plurality of reed switches is a normally-closed reed switch; and
at least one of the external magnets creates a magnetic field into which the normally-closed reed switch is placed to open the normally-closed reed switch.

3. An electronic device comprising the power supply coupling circuit of claim 1.

4. The electronic device of claim 3, wherein:
at least one of the plurality of reed switches is a normally-open reed switch; and
the electronic device further comprises at least one internal magnet arranged to create a magnetic field in which the normally-open reed switch is disposed to close the normally-open reed switch.

5. The electronic device of claim 4, wherein at least one of the external magnets disrupts the magnetic field in which the normally-open reed switch is disposed to open the normally-open reed switch.

6. The electronic device of claim 3, wherein:
at least two of the plurality of reed switches are normally-open reed switches;
the electronic device further comprises at least two internal magnets arranged to create at least two magnetic fields, each of the normally-open reed switches being disposed in one of the at least two magnetic fields to close each normally-open reed switch; and
the at least two internal magnets are arranged within the electronic device so that their poles are aligned in different directions.

7. The electronic device of claim 6, wherein the at least two internal magnets are arranged so that their poles face opposite directions from one another.

8. The electronic device of claim 6, wherein the at least two internal magnets are arranged so that their poles are oriented in a perpendicular arrangement with respect to one another.

9. An electronic device comprising:
a power supply;
a load; and
at least one reed switch connecting the power supply with the load;
wherein the at least one reed switch is disposed in a predetermined location within the electronic device such that a predetermined arrangement of at least one external magnet is required to open the at least one reed switch to disconnect the power supply from the load.

10. The electronic device of claim 9, wherein:
the at least one reed switch is a normally-closed reed switch; and
the at least one external magnet creates a magnetic field into which the normally-closed reed switch is placed to open the normally-closed reed switch.

11. The electronic device of claim 9, wherein:
the at least one reed switch is a normally-open reed switch; and
the electronic device further comprises at least one internal magnet arranged to create a magnetic field in which the normally-open reed switch is disposed to close the normally-open reed switch.

12. The electronic device of claim 11, wherein the at least one external magnet disrupts the magnetic field in which the normally-open reed switch is disposed to open the normally-open reed switch.

13. The electronic device of claim 9, wherein:
the at least one reed switch comprises at least two normally-open reed switches in parallel with one another;
the electronic device further comprises at least two internal magnets arranged to create at least two magnetic fields, each of the normally-open reed switches being disposed in one of the at least two magnetic fields to close each normally-open reed switch; and
the at least two internal magnets are arranged within the electronic device so that their poles are aligned in different directions.

14. A system comprising:
the electronic device of claim 9; and
a shipping device comprising the at least one external magnet, the shipping device configured to hold the electronic device in an orientation wherein the at least one external magnet is disposed in the predetermined arrangement relative to the electronic device.

15. A shipping device, comprising:
a package configured to hold an electronic device in a predetermined orientation; and
at least one magnet coupled to or embedded in the package, the at least one magnet being arranged to provide a predetermined arrangement of magnets relative to the electronic device held in the predetermined orientation, and the at least one magnet creating at least one magnetic field positioned to open at least one reed switch within the electronic device.
